(19) United States
(12) Patent Application Publication
(10) Pub. No.: US 2015/0096226 A1
(43) Pub. Date: Apr. 9, 2015

(54) Method and Apparatus for Non-dispersing Ground Cover

(71) Applicant: Wayne Krouse, Mountain Brook, AL (US)

(72) Inventor: Wayne Krouse, Mountain Brook, AL (US)

(21) Appl. No.: 14/508,012

(22) Filed: Oct. 7, 2014

Related U.S. Application Data
(60) Provisional application No. 61/888,201, filed on Oct. 8, 2013.

(51) Int. Cl. A01G 13/00

(52) U.S. Cl. CPC A01G 13/0268
USPC 47/20.1

(57) ABSTRACT

An enhanced ground cover whereby voids in the bodies are created for reception of material that exceeds the density of water that is placed in the voids for stable engagement by adhesive, fixing agents or by puncturing the material and inserting high density material or by embedding into the ground cover by high speed projectiles. The material may be covered in a sealant or UV inhibitor. A method includes flooding a reaction vessel with at least. two reactants, allowing reaction by product to settle fixably onto ground cover article. There is shown a method for treating ground cover adding a first substance to an article of ground cover, adding a second substance to the article, reacting the first and second substances to form a higher than water density third substance fixedly attached thereby making the ground cover of a higher than water density.

### CROSS REFERENCE TO RELATED APPLICATION

This application takes priority from U.S. Provisional Application for Patent No. 61/888,201 filed Oct. 8, 2013 entitled “Method and Apparatus for Non-dispersing Ground Cover” and is incorporated as if fully set forth herein.

### BACKGROUND OF THE INVENTION

1. Field of the Invention

This invention relates to landscaping ground cover, and more particularly to modified ground cover products regardless of type—wood, bark, paper, recycled paper, cellulose, plastic, synthetic etc to make ground cover heavier than the water to modify the average density of the ground cover so that it will sink and stay in place instead of washing away and thereby prevent its erosion. This also prevents the ground cover from being blown away by wind or yard blowers.

2. Description of Related Art

Various prior art patents have attempted to incorporate extraneous matter for planting of grass and the like. For example, U.S. Pat. No. 3,881,278 to Videen discloses a method of making a grass seeding for mass plantings which comprises the addition and admixing of a tackifier material so the seeds do not wash away.

Similarly other patents have attempted to bond materials to mulch. U.S. Pat. No 5,779,782 to Spittle discloses a mechanically-bonded, water-absorbent fiber mulch including natural and crimped synthetic fibers that are intimately mixed to form a mechanically-bonded fiber mulch.

U.S. Pat. No. 6,076,299 to Spittle et at discloses mulching pellets made from finely divided paper and wood, a clay binder, a highly water absorbent natural polymer, and surfactant for seed bedding.

U.S. Pat. No. 6,158,167 to Spittle discloses mulch flakes for seed beds made from finely divided paper and/or wood, and a surfactant. The flakes include surfactant which allows them to very quickly absorb about nine times their weight in water. And thus are faster to mix which reduces labor costs with hydro agitators.

U.S. Pat. No. 6,829,860 to Lee et at discloses a device for soil stabilization and grass and wildflowerseed enhancement comprising pelletized straw mulch having high bulk density, straw fibers, and fertilizing qualities.

U.S. Pat. No. 7,765,735 to Careili discloses a method of treating a mulch seed bed by applying an adhesive composition using portable apparatus including a disposable translucent container supported by a shoulder strap and connected to a wand distributor.

U.S. Pat. No. 8,256,159 to Spittle et at discloses a hydraulically-applied mulch comprising non-porous particles, porous particles and mixtures thereof combined with a mechanically and or chemically bonded fiber mulch mixed within a high viscosity slurry to keep the particles in suspension for dispersion onto soil surfaces with mulch spraying equipment for enhanced seed bed erosion control and higher level plant establishment.

U.S. Pat. No. RE28,950 to Jankowiak et al. discloses straw mats useful for covering soil to prevent wind and rain erosion are made by randomly distributing straw into a layer and binding the stalks together at their points of contact with at least about 75 pounds per ton of straw of a water resistant adhesive comprising a polymer of n alkenyl aromatic monomer, an open chain conjugated diene and an unsaturated carboxylic monomer blended with a water soluble cellulose ether and with an organosulfonate.

U.S. Patent Publication No. 2010/0313469 to Nixon-Lane discloses mulch or landscaping material that includes a plurality of loose particles that are combined with a water activated adhesive component.

U.S. Patent Publication No. 2011/0248423 to Proper et al. discloses a synthetic mulch formed of agglomerated plastic material that can be colored to have the look of a natural or organic mulch.

None of the prior art teaches or suggest the innovative methods and apparatus described herein. The present invention results in ground covers that stay in place during heavy rains and wind. Further, by increasing the density and weight of the ground cover, it resists blowing away in the presence of leaf blowers used by landscaping crews. An additional benefit of the invention is the ability to use such ground covers on inclined surfaces further reducing the erosion of the ground cover and the underlying soil.

### SUMMARY OF THE INVENTION

In accordance with a preferred embodiment of the invention there is disclosed an enhanced ground cover having a plurality of generally low density floatable bodies for placement on the ground useable to cover dirt, voids in the bodies for reception of material that exceeds the density of water; and material fixedly placed in the voids for stable engagement to said bodies by adhesive or other fixing agents.

In accordance with another preferred embodiment of the invention, there is shown a method for treating ground cover having the steps of moving organic or inorganic ground cover material on a conveyor past a rotating drum, subjecting the ground cover material to projections on the rotating drum with sufficient pressure to impart voids in the ground cover material, and inserting in the voids higher than water density material.

In accordance with another preferred embodiment of the invention, there is shown a method for treating ground cover having the steps of moving organic or inorganic ground cover article into a reaction vessel, flooding the reaction vessel with at least two reactants, allowing reaction by product to settle fixably onto ground cover article.

In accordance with another preferred embodiment of the invention, there is shown a method for treating ground cover having the steps of moving organic or inorganic ground cover material on a conveyor past a system that delivers the high density material at high speeds, subjecting the ground cover material to projectiles with sufficient pressure to embed projectiles in the ground cover material, and fixedly attaching the higher than water density material into said voids for stable engagement in said voids.

In accordance with another preferred embodiment of the invention, there is shown a method for treating ground cover having the steps of adding a first substance to an article of ground cover, adding a second substance to the article, reacting the first and second substances to form a higher than water density third substance fixedly attached to the article of ground cover thereby making the ground cover of a higher than water density.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic diagram of ground cover according to a preferred embodiment of the invention,

FIG. 2A is a schematic diagram of ground cover according to a preferred embodiment of the invention.

FIG. 2B is a schematic diagram of a method for weighting ground cover according to a preferred embodiment of the invention.

FIG. 2C is a schematic diagram of another method for weighting ground cover according to a preferred embodiment of the invention.

FIG. 3 is a schematic diagram of another method for weighting ground cover according to a preferred embodiment of the invention.

FIG. 4 is a schematic diagram of another method for weighting ground cover according to a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the issued claims and as a representative basis for teaching one skilled in the art to employ the present invention in virtually any appropriately detailed system, structure or manner.

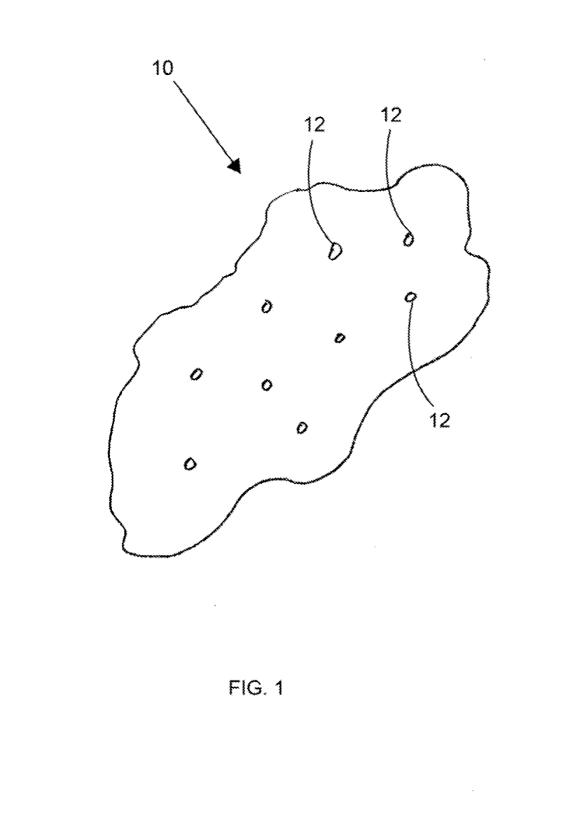

As shown in FIG. 1, there is shown ground cover article 10 having bodies 12 adhesively attached to ground cover article 10 to increase the density of ground cover article 10. By using bodies 12 of higher density than that of water, the ground cover article will sink when placed in or around a body of water, puddle or heavy rain. In a preferred embodiment, the ground cover material may be enhanced by using an adhesive to attach a material with a high enough density so that the average density of each individual particle is higher than that of the density of the water, thus sinking the ground cover and thereby staying the ground cover in place instead of washing away. This also prevents the ground cover from being blown away by wind or yard blowers. Any of a number of materials may be used and adhered to the ground cover material. These materials may be attached through conventional adhesives, thermoplastic adhesives, or through other sticky substances that generally withstand decomposition in water, ultraviolet light or sunlight.

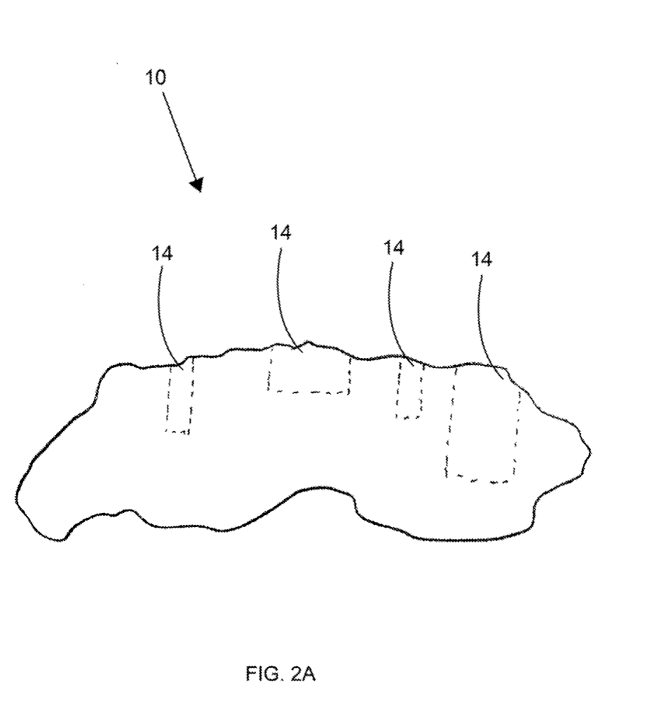

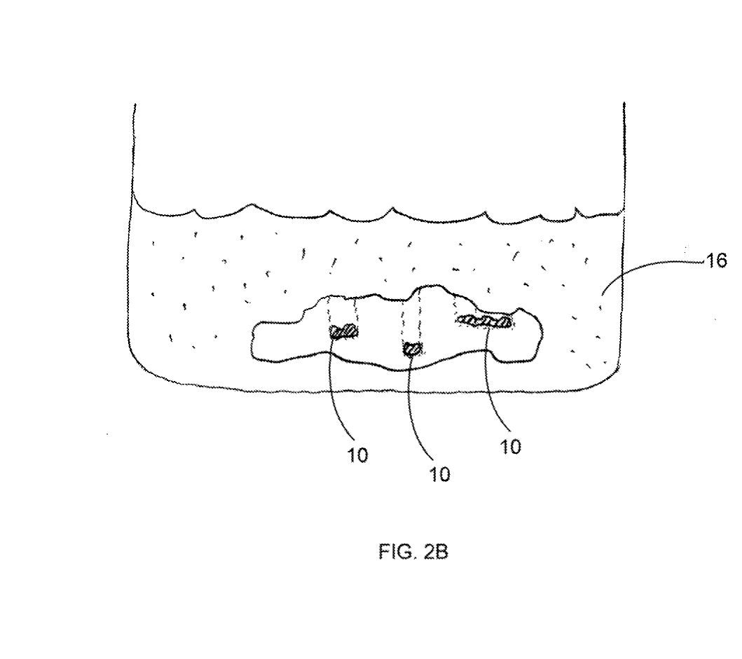

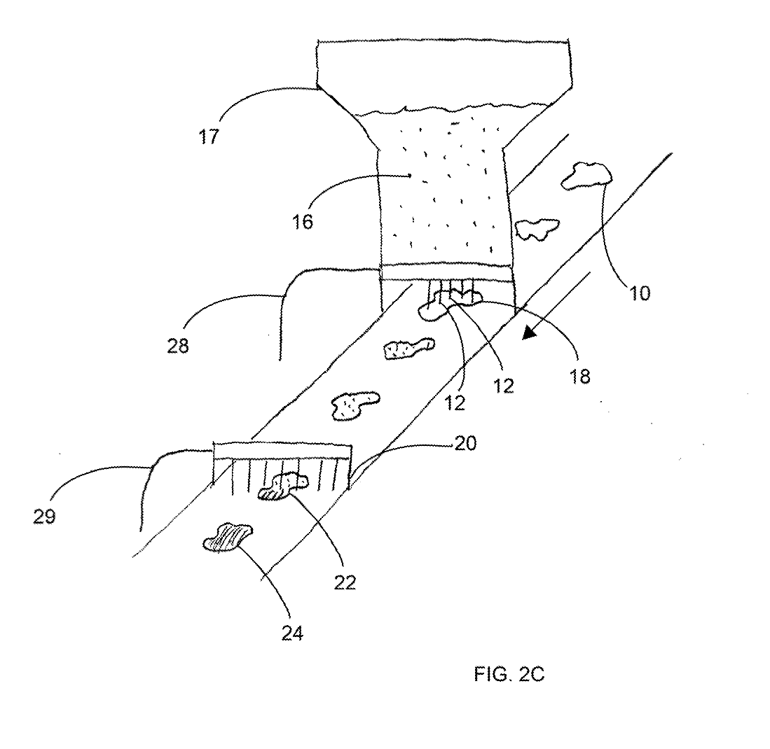

Turning now to FIG. 2A, there is shown another preferred embodiment which involves drilling holes 14 into the ground cover article or ground cover article 10 and filling the holes with a material with a high enough density so that the average density of the individual ground cover article is higher than that of the density of the water, thus sinking and thereby staying in place instead of washing away. This also prevents the ground cover from being blown away by wind or yard blowers. Ground cover article 10 is subjected to known processes for creating holes 14 in the individual ground cover article pieces. Drilling of the holes is but one method of eking the holes. Holes 14 may be of any of a variety of diameters and depths and combinations thereof and may be different so long as they are capable of being filled with a higher density material that generally stays in place while exposed to water, sunlight or ultraviolet Filling the holes may be accomplished by exposing the ground cover article in a bath of higher density material 16 as shown in FIG. 2B, or by individual placement of such material into the holes. Once impregnated with higher density material, ground cover article 10 is rendered sinkable in water. This also prevents the ground cover from being blown away by wind or yard blowers.

As shown in FIG. 2C, holes may be filled by manually or mechanically placing higher density material 16 into the holes in the ground cover article whether through hopper 17 or by feed line 28. Bodies 12 may be punctured by needles 18 or by previous method so long as the higher density material 16 may be inserted into holes 14 as ground cover article 10 moves under hopper 17. By using the method of inserting holes into the ground cover article they may be later covered or injected with a sealant 22 with depositor 20 fed by pressure line 29 to prevent the high density material from exiting the holes and the ground cover article, resulting in a high enough density so that the average density of the individual ground cover article is higher than that of the density of the water, thus sinking and thereby staying the ground cover in place instead of washing away. The sealant prevents the high density material from falling out of, eroding from or exiting the ground cover article. Once sealed, resultant ground cover article 24 is permitted to dry and cure. This also prevents the ground cover from being blown away by wind or yard blowers. Additional material may be applied to the finished ground cover such as UV inhibitors to prevent degradation of the adhesive or sealant material.

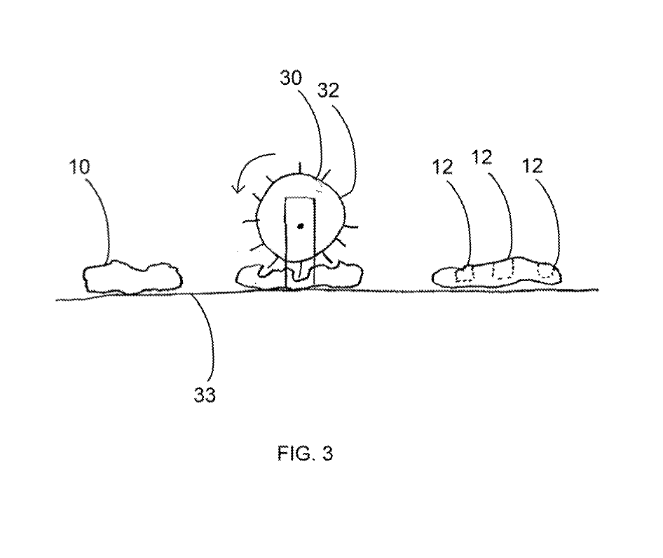

Turning to FIG. 3, here is shown method for creating holes in ground cover article 10. Ground cover article 10 or ground cover may be acted upon by a rotating pin 30 shown rotating counterclockwise from movement of conveyor 33 with spokes 32, (spikes or automated hole punchers or other protrusions) that have the ability to penetrate the individual ground cover articles and create openings or hole 14 for later addition of higher density material.

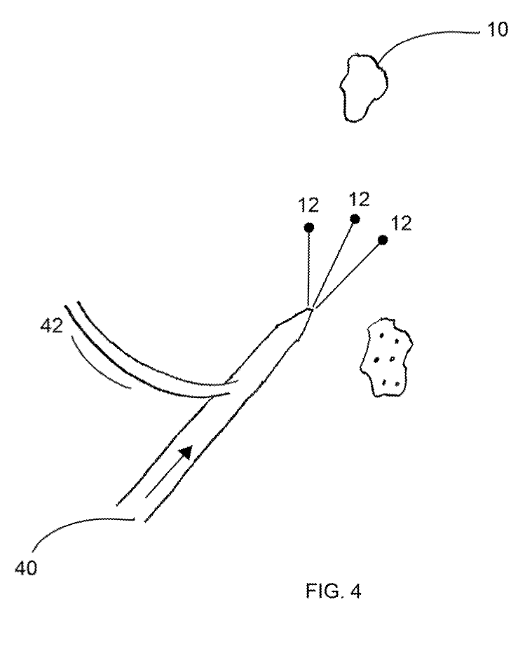

As seen in FIG. 4, in yet another preferred embodiment, the ground cover article 10 may be enhanced by shooting higher density materials 16 into the ground cover article thereby lodging the high density material in the ground cover article with a high enough density so that the average density of the individual ground cover article is higher than that of the density of the water, thus sinking and thereby staying the ground cover in place instead of washing away. This also prevents the ground cover from being blown away by wind or yard blowers. Compressed air 40 accelerates high density material 16 fed from intake tube 42 which in turn impacts ground cover article 10 with sufficient force to lodge higher density material 16 into ground cover article 10. This heavier ground cover article also prevents the ground cover from being blown away by wind or yard blowers. This may be alternatively accomplished by any of a variety of mechanisms including gun type devices that can shoot projectiles into the ground cover articles or by subjecting the ground cover to a firing squad type system whereby as the ground cover article passes a single location, material is shot into the ground cover article.

In still another preferred embodiment, a ground cover article material may be mixed with a high density material and adhesive in a batch or continuous process and then mechanically formed into a mixture of a higher density ground cover product for placing on the surface of the ground cover article. In this embodiment, the resultant mixture includes ground cover material and higher density material and avoids washing away. This also prevents the ground cover from being blown away by wind or yard blowers.

In still yet another embodiment, the ground cover article is enhanced by adding a material “A” to the article and then adding a material “B” to the article so that A & B react to form a product that is equaled to the ground cover article plus the reaction product of (A+B) or ground cover+(A+B) and changes the ground cover density so that the average density of the individual article is higher than that of the density of the water, thus sinking and thereby staying in place instead of washing away or being blown away by wind or yard blowers. The reaction systems are not intended to be limited to a binary system and could have three, four or more reactants. It G also possible to mix A and B (and C and D etc.) together first and then add the reaction product to the ground cover article, A or B or C or D etc can be inserted as well and be the density modifier. One example may be the use of polyepoxides or epoxy resins that react to form a second hardened substance.

As can readily be seen, any of the above methods may be done in situ or on site, rather than in the manufacturing process at a different location. One concept could be rotating burrs that the ground cover article passes through that mechanically alter the surface of the ground cover article to allow for better adhesion of the density modifier or the reaction product mixtures. Mechanical surface modification can be accomplished by many number of means not intended to be limited to offset rotating burrs.

A method of applying a higher density material may be accomplished by a cascade waterfall system whereby the ground cover is conveyed under a sprayer or cascade of adhesive material that adheres to the material. The adhesive material can also be the high density material or the cascade can have the higher density material in the adhesive waterfall. As the article passes under the cascade from above, higher density material is applied to the article. This may also be accomplished by applying an adhesive to the ground cover by a similar waterfall or cascade or sprayer, and then subsequently spraying, or dropping higher density material onto the ground cover article so it adheres by way of the adhesive.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the issued claims.

1. An enhanced ground cover comprising:
a plurality of generally low density floatable bodies for placement on the ground useable to cover dirt;
voids in said bodies for reception of material that exceeds the density of water; and
material fixedly placed in said voids for stable engagement to said bodies.

2. The enhanced ground cover as claimed in claim 1 further comprising sealant applied to said voids after being filled with said material.

3. The enhanced ground cover of claim 1 further comprising adhesive in said voids.

4. The enhanced ground cover of claim 1 further comprising sealant over said material in said voids.

5. The enhanced ground cover of claim 1 further comprising UV inhibitors on said floatable bodies.

6. A method for treating ground cover comprising the steps of
moving organic or inorganic ground cover material on a conveyor with localized pressure to impart voids in said ground cover material;
inserting in said voids higher than water density material; and
fixedly attaching said higher than water density material into said voids for stable engagement in said voids.

7. The method for treating ground cover of claim 6 further comprising the step of delivering said material from a hopper.

8. The method for treating ground cover of claim 6 further comprising the step of substantially sealing said void after attaching said material.

9. The method for treating ground cover of claim 6 further comprising subjecting said ground cover material to projections on a rotating drum

10. The method for treating ground cover of claim 6 further comprising applying said pressure with projectiles with sufficient pressure to create voids and embed said projectiles in said ground cover material.

11. The method for treating ground cover of claim 10 further comprising a pressurized hose for delivery of said projectiles.

12. The method for treating ground cover of claim 10 further comprising the step of substantially sealing said voids after said projectiles are embedded

13. The method for treating ground cover of claim 6 further comprising a stationary system to embed high density projectiles in the ground cover.

14. A method for treating ground cover comprising the steps of:
moving organic or inorganic ground cover article into a reaction vessel;
flooding said reaction vessel with at least two reactants; and
allowing reaction by product to settle fixably onto ground cover article.

15. The method for treating ground cover of claim 14 further comprising the step of reacting said ground cover with said one of said at least two reactants.

16. The method for treating ground cover of claim 14 further comprising the steps of reacting said first and second reactants to form a higher than water density third substance fixedly attached to said article of ground cover thereby making said ground cover of a higher than water density.

17. The method for treating ground cover of claim 16 further comprising treating said ground cover with an adhesive after reacting said first and second reactants.

18. The method for treating ground cover of claim 14 herein said first reactant is an epoxy resin.
